(19) United States
(12) Patent Application Publication
(10) Pub. No.: US 2013/0167069 A1
(43) Pub. Date: Jun. 27, 2013

(54) SCROLL CONTROL METHOD, SCROLL CONTROL APPARATUS, AND PROGRAM

(71) Applicant: Canon Kabushiki Kaisha, Tokyo (JP)

(72) Inventor: Naoto Abe, Machida-shi (JP)

(73) Assignee: CANON KABUSHIKI KAISHA, Tokyo (JP)

(21) Appl. No.: 13/706,235

(22) Filed: Dec. 5, 2012

(30) Foreign Application Priority Data
Dec. 27, 2011 (JP) 2011-286780

(51) Int. Cl. G06F 3/0485

(52) U.S. Cl. CPC G06F 3/0485
USPC 715/784

(57) ABSTRACT

A scroll control method for aiding works including displaying a partial area of an image of an observation object on a display apparatus and moving a display area within the image to observe the image includes, by a computer, a first calculation step, a second calculation step, and a display control step. The first calculation step calculates a first direction of movement and first movement speed based on information on time and coordinates on a movement selected with a pointing device and instructed to operate. The second calculation step calculates a second direction of movement and a second movement speed from the first direction of movement and first movement speed. The display control step performs scroll control over the display area based on the second direction of movement and movement speed.

### BACKGROUND OF THE INVENTION

1. Field of the Invention

The present invention relates to a user interface which aids works including partially displaying and observing an image acquired by imaging an analyte and particularly relates to a scroll control method, a scroll control apparatus, and a program.

2. Description of the Related Art

In the past, a scroll control method has been proposed in which scroll control is performed with a mouse operated by an observer on movement of a display area for displaying an image, particularly on scroll of a display area. (Japanese Patent Laid-Open No. 2-266398) For example, Japanese Patent Laid-Open No. 2-266398 provides scroll control apparatus for a display screen which allows a scroll operation to meet with human sensibilities by freely scrolling an entire display screen in accordance with the direction of movement and movement speed of a mouse body for improved efficiency of design works.

Japanese Patent Laid-Open No. 11-154074 may solve a problem that grasping the state of movement is difficult when the scrolling increment per unit time is high in a display apparatus having a low display response late like a liquid crystal display apparatus (LCD). In order to solve the problem, Japanese Patent Laid-Open No. 11-154074 discloses a scroll control apparatus which sets scrolling increments in stepwise manner and sets scrolling increments upon scroll start and scroll end to different increments from others.

The present inventors have studied and developed a system which allows observation of an image captured with a digital microscope called a virtual microscope by using observation software called a viewer.

When a high resolution image captured by a digital microscope or an examination apparatus is subject to a diagnosis or an examination (hereinafter, called an observation) on a screen of a display apparatus, the rendering area (displayable pixel counts) of the display apparatus may generally be narrower than the resolution of the image. This may prevent screen display of the entire image. Accordingly, a method has been proposed which includes displaying a partial area (display area) of an image to be examined on a display apparatus and moving the display area within the image for observation of the entire image.

The method disclosed in Japanese Patent Laid-Open No. 2-266398, that is, the technology of scrolling in accordance with the direction of movement and movement speed of a mouse body allows a scroll operation to meet with human sensibilities. However, in the viewer studied and developed by the present inventors, it has been found that the scrolling in accordance with the direction of movement and movement speed which may be arbitrarily determined with a mouse body is a malfunction on the other hand. In other words, there is a possibility that a malfunction of causing an image part which may not be observed due to a displacement of the direction of movement caused by the arbitrary determination of the direction of movement with a mouse body though the entire image is required to scroll for comprehensive check without unobserved parts. There is another possibility that a malfunction occurs in which variations in movement speed generate variations in observation results because the movement speed may also be arbitrarily determined with a mouse body.

In recent years, display apparatuses called a hold type display such as an LCD having been mainstream as display apparatuses. Less flickering of a hold type display such as an LCD may allow high image quality display for observation of a still image. However, a blur called motion blur (hold blur) may occur when a hold type display displays moving images. The term “motion blur” refers to a phenomenon in which a difference occurring between an actual display position and a viewpoint position due to the many light emissions by a display element in a display refresh period is stored in the retina and is observed as a blur while moving pictures are being pursued by an observer. Recent LCDs are taking some measures against it, but the blur occurs in principle independent of the display speed (response rate of the display element) in a hold type display. The method disclosed in Japanese Patent Laid-Open No. 11-154074 proposes a method which allows easy check of the state of movement by focusing on the display speed (response rate) of a display element. However, it does not disclose a method which may prevent motion blur and facilitate observation by scrolling by an observer.

### SUMMARY OF THE INVENTION

According to one aspect of the present invention, a scroll control method for aiding works including displaying a partial area of an image of an observation object on a display apparatus and moving a display area within the image to observe the image, includes a first calculation step of calculating, by a computer, a first direction of movement and first movement speed based on information on time and coordinates on a movement selected with a pointing device and instructed to operate, a second calculation step of calculating, by the computer, a second direction of movement and a second movement speed from the first direction of movement and first movement speed, and a display control step of performing, by the computer, scroll control over the display area based on the second direction of movement and movement speed.

According to another aspect of the present invention, a scroll control method for aiding works including displaying a partial area of an image of an observation object on a display apparatus and moving the display area within the image to observe the image includes the steps of determining, by a computer and in response to a time for moving, at a designated movement speed, a travel distance overlapping display areas in a designated direction of scrolling being handled as a cycle of the time for moving at the designated movement speed, movement speeds which are periodically changing between a third movement speed and a fourth movement speed that is higher than the third movement speed, and performing, by the computer, scroll control over a displayed image based on designated direction of scrolling and the movement speeds which are repeated changing third movement speed and fourth movement speed.

A scroll control method according to another aspect of the present invention allows easy scrolling for comprehensive check of the entire image without unobserved parts.

A scroll control method according to another aspect of the present invention allows an observer to observe easily with less motion blur on a hold type display such as an LCD.

Further features of the present invention will become apparent from the following description of exemplary embodiments with reference to the attached drawings.

### BRIEF DESCRIPTION OF THE DRAWINGS

FIG. 1 is a flowchart illustrating an operation by a viewer which implements the first embodiment of the present invention.

FIG. 2 schematically shows the specific method of acquiring the first direction of movement and first movement speed.

FIG. 3 is a flowchart illustrating an operation by a viewer which implements the second embodiment.

FIG. 4 is a flowchart illustrating an operation by a viewer which implements the third embodiment.

FIG. 5 is a flowchart illustrating an operation by a viewer that implements the fourth embodiment.

FIG. 6 is a graph illustrating a relationship between the time and position of the display area of scrolling according to the fourth embodiment.

FIG. 7 is a graph illustrating a relationship between time and movement speed according to the fourth embodiment.

FIG. 8 is a graph illustrating an improved relationship between time and movement speed of the fourth embodiment.

FIG. 9 is a graph illustrating a further improved relationship between the time and movement speed of the fourth embodiment.

FIG. 10 illustrates a configuration of a computer system in which a viewer operates.

FIG. 11A schematically illustrates an image to be observed.

FIG. 11B schematically illustrates a display area to be displayed on a display apparatus.

FIG. 12A schematically illustrates an operation of scrolling an image to be observed in a longitudinal direction.

FIG. 12B schematically illustrates an operation if scrolling the image to be observed in a lateral direction.

FIG. 13A schematically illustrates an operation of scrolling an image to be observed in a longitudinal direction.

FIG. 13B is a zooming view of a part of FIG. 13A.

FIG. 14A illustrates motion blur (impulse type display).

FIG. 14B illustrates motion blur (hold type display).

### DESCRIPTION OF THE EMBODIMENTS

Embodiments relate to a scroll control method for aiding works including displaying a partial area (display area) of an image to be observed on a display apparatus and moving the display area within the image for observation of the image. The scroll control method may be suitably adaptable to a work of observing the entire image to be observed by allowing zooming and scrolling a partial area (display area) for observing an image to be observed which has been captured at a high resolution.

A system which captures an image with a digital microscope(virtual microscope) for observation through a viewer is a specific example of applications of the works including displaying a partial area (display area) of an image to be observed on a display apparatus and moving the display area within the image to observe the image. This system is called a digital microscope system (virtual slide system). A viewer in a digital microscope system will be described, for example, to describe a scroll control method more specifically herein.

### Operating Environment of Viewer

First of all, the environment in which a viewer operates will be described.

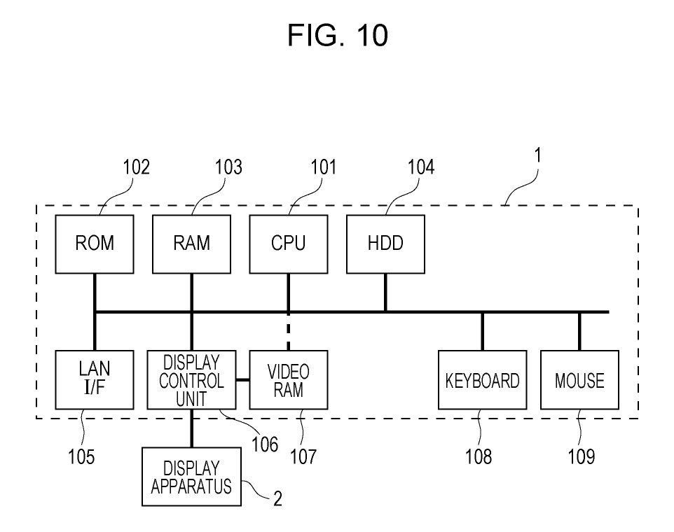

FIG. 10 illustrates a configuration of a computer system in which a viewer operates. Referring to FIG. 10, the viewer operates in a computer (scroll control apparatus) 1, and a display apparatus 2 is provided. The computer 1 includes a CPU 101, a ROM 102, a RAM 103, a hard disk drive (HDD) 104, a LAN interface (LAN I/F) 105, a display control unit 106, and a video RAM 107. The computer 1 further includes a keyboard 108 and a mouse 109.

In the configuration in FIG. 10, the computer 1 starts and operates observation software (program) called a viewer stored in the HDD 104. The viewer may be stored in the HDD 104 or ROM 102 or may be downloaded from a server not illustrated through the LAN I/F 105 for execution. When the viewer starts, the CPU 101 acquires image data from the server not illustrated through the LAN I/F 105 and stores it in the RAM 101. The image data may be stored in the HDD 104 of the computer 1, for example, not limited to the acquisition from the server. The CPU 101 writes a part of the image data stored in the RAM 101 (image data of a display area) to the video RAM 107 through the display control unit 106 for desirable display, as will be described below. Alternatively, it may be designed such that the program may cause the CPU 101 to execute a function of the display control unit and the allow CPU 101 to directly write to the video RAM 107, as indicated by the illustrated broken line. On the other hand, the CPU 101 periodically reads an instruction from the keyboard 108 and/or an instruction from the mouse 109. The CPU 101 then writes image data on the display area to the video RAM 107 in response to an instruction from the keyboard 108 and/or an instruction from the mouse 109 for desirable display. The mouse 109 is applicable in the same manner even if it is any of other kinds of pointing device such as a track pad.

### Operations by Viewer

Next, an operation of moving (scrolling) the display area on an image to be observed within an image to observe the image will be described which is important among operations by the viewer.

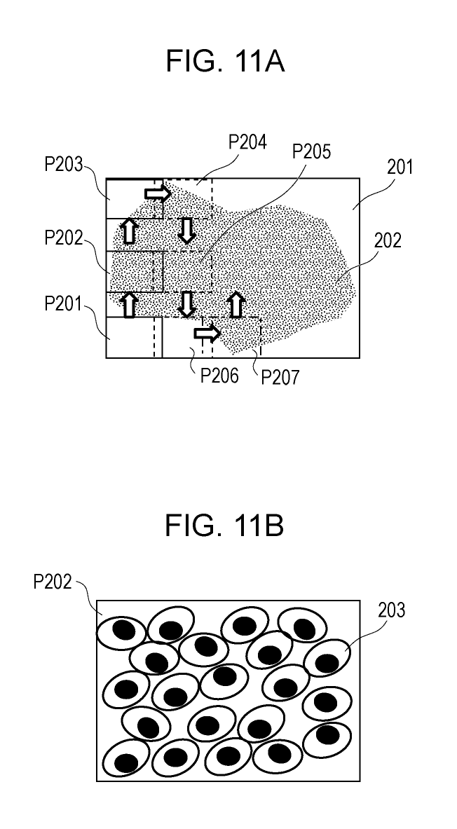

FIGS. 11A and 11B are schematic diagrams illustrating a scrolling operation by the viewer. FIG. 11A schematically illustrates an image to be observed, and FIG. 11B schematically illustrates a display area to be displayed on a display apparatus. An analyte may be a sample being analyzed or undergoing analysis. FIGS. 11A and 11B schematically illustrate an image to be observed 201, an analyte 202 in the image to be observed 201 and a zoomed analyte 203. Partial areas P201 to P207 of the image to be observed are display areas which may be displayed on a display apparatus at certain times. The display area moves in the direction indicated by the arrow illustrated in FIG. 11A. The position of the part (display window) for displaying the display area on the display screen of the display apparatus is fixed, and the display area being displayed moves. As a result, the image within the display window appears to move (scroll) in the opposite direction of the movement of the display area.

As illustrated in FIG. 11A, scrolling the image to be observed 201 closely allows full observation of the image to be observed or analyte.

### Scroll

Next, the scrolling will further be described.

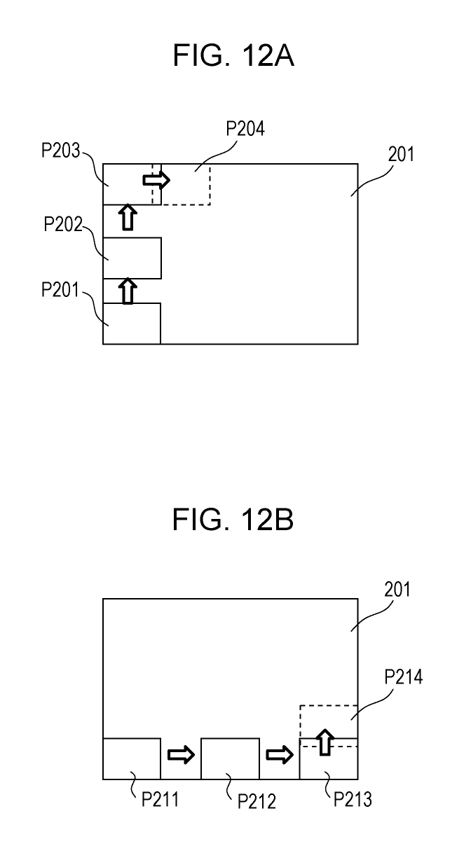

FIGS. 12A and 12B illustrate scrolling by the viewer. FIG. 12A schematically illustrates an operation of scrolling an image to be observed in a longitudinal direction, and FIG. 12B schematically illustrates an operation if scrolling the image to be observed in a lateral direction.

The repetitive recitations of the reference numerals recited in FIGS. 11A and 11B are omitted in FIGS. 12A and 12B. FIGS. 12A and 12B schematically illustrates an analyte for clear illustration of the scrolling. FIGS. 12A and 12B include partial areas P211 to P214 of the image to be observed, which are display areas that may be displayed on a display apparatus at certain times.

Referring to FIG. 12A, the display area P201 moves upward (scrolling in the longitudinal direction) and moves in the right direction (scrolling in the lateral direction) such that the display areas may partially overlap at the upper end (P203) of the image to be observed (P204). After that, the display area is moved downward for sequential display. Such scrolling allows close observation of the entire image of the observation object. Referring to FIG. 12B, the display area P211 first moves in the right direction (scrolling in the lateral direction) and moves upward (scrolling in the longitudinal direction) such that the display areas may overlap at the right end (P213) of the image to be observed (P214). After that, the display area moves in the left direction for sequential display. Such scrolling allows close observation of the entire image of the observation object. The direction of scrolling may be determined in accordance with the type of the analyte, the size of the image and/or a preference of the observer. The display area may be moved each time in response to an instruction from an observer through a pointing device such as the mouse 109, for example. In this case, however, the observer may be required to perform the task of designating regarding the movement while observing, which may prevent the observer from concentrating on the observation.

### Motion Blur

Next, motion blur will be described. Motion blur significantly appears on a display apparatus called a hold type display such as an LCD or an organic electroluminescence display. A general hold type display has a thin film transistor (TFT) in each of display elements and provides high-luminance display by assigning most time of a display refresh period to the time for light emission. This kind of display may sometimes be called an active matrix display.

In this hold type display, because most time of a display refresh period may be assigned to the time for light emission, as described above, a high luminance display apparatus may easily and beneficially be implemented. Furthermore, flicker on display screen may be prevented, which may provide an observer viewing the display apparatus with display without interference. This benefit particularly becomes significant while a still image is being observed.

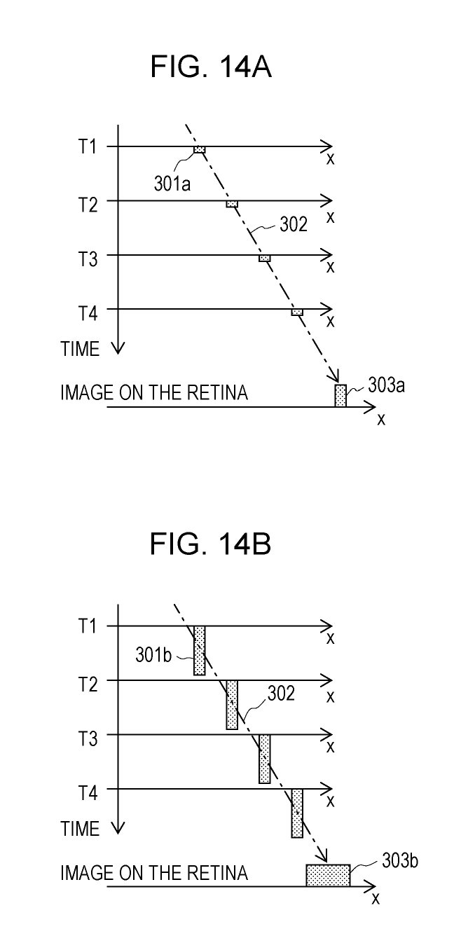

However, blur called motion blur occurs when a moving picture (an image resulting from scrolling over a still image particularly) is being observed. Motion blur may occur for the following reason or reasons. FIGS. 14A and 14B illustrate motion blur. FIGS. 14A and 14B have a longitudinal axis indicating times and a lateral axis indicating an X direction. FIGS. 14A and 14B include times and positions 301a, 301b where a display element is emitting light, the movement 302 of the line of vision of an observer, and images 303a and 303b on the retina of the observer. FIG. 14A schematically illustrates images on the retina when a moving picture is displayed on an impulse type display such as a CRT and is pursued by an observer. The image is moving from a time T1 to a time T4. However, because of the short light emitting time (301a), the image on the retina extends less in the X direction even when the observer pursues a movie. This means that blur hardly occurs. On the other hand, when a moving picture is display on an hold type display such as an LCD, the image on the retina resulting from the pursuit by the observer extends in the X direction as illustrated in FIG. 14B (meaning that blur is occurring). This motion blur occurs because the display element emits light for most of the display refresh period. This phenomenon also occurs with an unlimitedly high display speed (response rate) of the display element. This phenomenon is different from the phenomenon caused by some display speed (response rate) of a display element that is the problem recited in Japanese Patent Laid-Open No. 11-154074.

The motion blur as described above is a phenomenon that blur resulting from the difference stored on the retina between an actual display position and a view point position when the observer is pursuing a moving picture and the display element emits light for most of a display refresh period.

As a measure against this problem, recent LCDs may insert a black screen or have a backlight emitting light for a shorter period of time, which are however not perfect. The motion blur occurs in principle regardless of the display speed (response rate) of a display element in a hold type display.

### First Embodiment

Next, a first embodiment will be described. According to a first embodiment, the scrolling in the longitudinal direction in FIG. 12A and the scrolling in the lateral direction in FIG. 12B are automated in response to an instruction from the mouse 109 or the like.

Normally, when the mouse 109 is moved (or dragged) with a button selected, manual scrolling occurs which moves a displayed image by following the move of the pointer. Preferably, an observer may select one of the manual scrolling mode and a mode in which the scrolling may be operated as required. For example, the mode switching may be performed with a function key on the keyboard 108 where both of the modes are preset to the function key. An operation of the viewer when the mode is set will be described below.

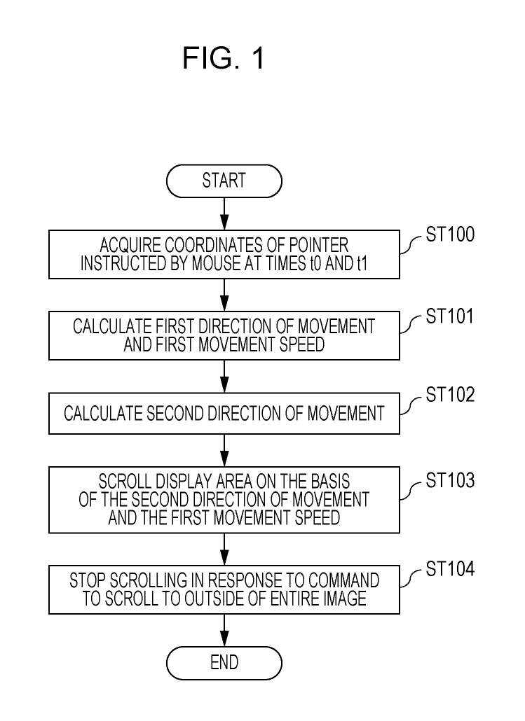

FIG. 1 is a flowchart illustrating an operation by the viewer which implements the first embodiment. The details of the operation will be described with reference to the flowchart in FIG. 1.

The following operation is performed in accordance with the flowchart in FIG. 1 when the mouse 109 is instructed to move with a button thereon selected (dragged). In step ST100, the coordinates of the pointer instructed through the mouse 109 at times t0 and t1 are acquired. Next, from the information on the coordinates of the pointer instructed through the mouse 109 at times t0 and t1, a first direction of movement and a first movement speed are acquired (first calculation step: step ST101). Details on how to acquire the coordinates will be described below. Next, from the first direction of movement, a second direction of movement is calculated (second calculation step: step ST102). For example, the second direction of movement may be limited to a longitudinal or lateral direction, and a longitudinal or lateral direction close to the first direction of movement is selected. Next, a display area is moved at the first movement speed in the second direction of movement for display (step ST103). In this manner, the scrolling in a longitudinal or lateral direction which is originally to be performed may be automated even when the mouse 109 instructs a movement in a slightly deviated direction.

Then, when the display area reaches an end of the entire image of the observation object, the movement of the display area stops. This may be implemented by gradually reducing the scroll movement speed in the vicinity of an end of the entire image and stopping at the end of the entire image of the observation object (step ST104). Alternatively, after the display area may stand still at P203 (P213) illustrated in FIG. 12B in step ST104, the display area automatically may move to the position of the next observation start area P204 (P214).

Through this flow, in response to an instruction issued by an operation on the mouse 109, the scrolling from P201 to P203 illustrated in FIG. 12A, and scrolling from P211 to P213 may be automatically performed.

Alternatively, in step ST104, the movement of the display area may stop if it is determined that no analyte exists within the display area before the display area reaches an end of the entire image of an observation object. No analyte may be determined from the magnitude of the total sum of the differentiation values of the image data of each of a plurality of divided blocks of the entire image of the observation object. If the total sum is high, it means that there is an analyte. The presence of an analyte may alternatively be determined from the sum of the brightnesses of pixels in each block (that is, the sum of image data of pixels) if the image is captured by a normal microscope. Because illumination light is directly captured through a prepared slide in a part without an analyte, the sum of the brightnesses of pixels of a block is high. Conversely, in a dark-field photographed image, no analyte may be determined if the sum of the brightnesses of pixels of a block is low.

This operation of moving a display area in step ST104 is applicable to other embodiments which will be described below.

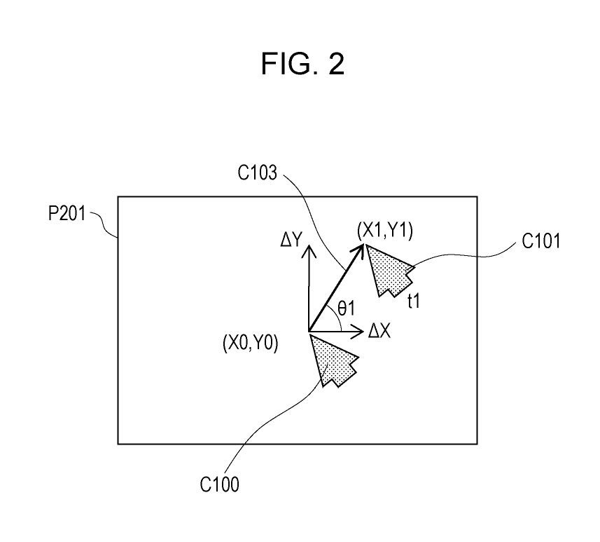

Next, a specific method of acquiring the first direction of movement and first movement speed from coordinates of the pointer instructed through the mouse 109 at times t0 and t1 in step ST101 (first calculation step) will be described with reference to FIG. 2. FIG. 2 schematically shows the specific method of acquiring the first direction of movement and first movement speed. The description on the aforementioned reference numerals will be omitted in FIG. 2. FIG. 2 illustrates a position (X0,Y0) C100 of the pointer at a time to, a position (X1,Y1) C101 of the pointer at the time t1, and a movement vector C102 of the pointer from the time t0 to the time t1. In this case, the first direction of movement refers to the direction of the vector, and the first movement speed refers to the value as a result of the division of the length of the vector by the time (t1-t0). The times t0 and t1 may be timer interrupt times, for example. The CPU 101 checks the movement state of the mouse 109 and calculates the position of the corresponding pointer. The times t0 and t1 may be correctly selected in accordance with the speed of operations by an observer. The interval between the times t0 and t1 may generally be a time in the range from several msec. to 100 msec.

The direction of movement may be calculated by Expression 1:

θ1=tan⁻¹((Y1−Y0)/(X1−X0))

where the angle is equal to θ1 in FIG. 2. The first movement speed may be calculated by Expression 2:

V1=((X1−X0)2+(Y1−Y0)²)^{(1/2)}/(t1−t0)

A specific method of acquiring a second direction in step ST102 (second calculation step) will be described below. A second direction (angle θ2) may be calculated by Expression 3:

θ2=Int((θ1+45)/90)×90

In this case, the unit of the angle is the degree, and the function Int( ) is the function that returns the integer part within parentheses. Expression 3 limits the possible range of the second direction to the longitudinal or lateral direction about 45 degrees (half of 90 degrees). The specific method for acquiring the second direction is not limited to Expression 3, but the second direction may be acquired by, for example, Expression 4:

θ2=Int((θ1+22.5)/45)×45

In this case, the possible direction may be limited in steps of 45 degrees.

The second direction may be limited to a lateral direction or a longitudinal direction only. For example, this may prevent scrolling to a direction departing from the limited range when the direction to be observed is limited.

A longitudinal direction, for example, may be suggested for the designation of the second direction for the movement of the pointer designated by the mouse 109, as expressed by Expression 5. This allows limitation of an easy-to-designate direction if there is a desirable direction of scrolling for an observation.

θ2=0(−30<θ1<30)

θ2=90(30≦θ1≦150)

θ2=180(150<θ1<210)

θ2=270(210≦θ1≦330) Expression 5:

In this manner, a second direction of movement may be acquired from the first direction of movement.

In this manner, the scroll control method of the first embodiment allows easy scrolling for comprehensive check of the entire image without unobserved parts.

According to the scroll method of the first embodiment, an analyte may automatically be scrolled and displayed in accordance with the direction of movement (second direction of movement) that is preferably for its observation and the movement speed (first movement speed) designated by an observer with the mouse 109. Therefore, the scroll method of the first embodiment may reduce the load imposed on the observer who designates a scroll operation. As a result, the observer may be allowed to concentrate his or her observation. Furthermore, because the second direction of movement is limited, easy scrolling is allowed for comprehensive check of the entire image without unobserved parts.

### Second Embodiment

Next, a second embodiment will be described. The second embodiment is a method according to the scroll method of the first embodiment, further including calculating a second movement speed from a first movement speed, displaying a display area in accordance with a second direction of movement and the second movement speed on the display apparatus and moving (scrolling) the display area within an image.

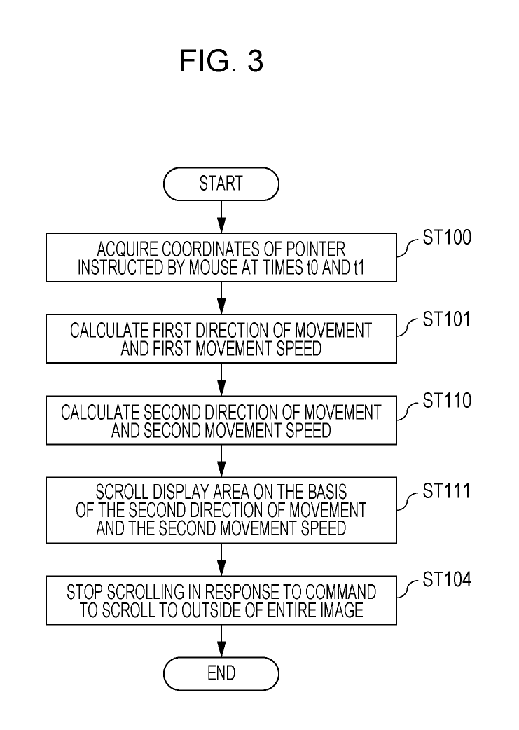

FIG. 3 is a flowchart illustrating an operation by the viewer which implements the second embodiment. The details of the operation will be described with reference to the flowchart in FIG. 3.

Similar to the first embodiment, an operation by the viewer will be described with a mode preset.

First of all, when the mouse 109 moves with a button thereon selected (dragged), the following operation is performed in accordance with the flowchart in FIG. 2. The coordinates of the pointer instructed through the mouse 109 at times t0 and t1 are acquired (step ST100). Next, from the coordinates of the pointer instructed through the mouse 109 at times t0 and t1, a first direction of movement and a first movement speed are acquired (first calculation step: step ST101). Details on how to acquire the coordinates are as described above. Next, from the first direction of movement and the first movement speed, a second direction of movement and a second movement speed are calculated (second calculation step: step ST110). For example, the second direction of movement may be calculated in the same manner as the first embodiment. The second movement speed will be described below. Next, a display area is moved at the second movement speed in the second direction of movement for display (step ST103). Then, when the display area reaches an end of the entire image of the observation object, the movement of the display area stops. This may be implemented by gradually reducing the speed and stopping (step ST104). The operation in step ST104 may further includes the operation according to the first embodiment.

A method (second calculation step) of calculating a second movement speed from a first movement speed will be described below. Because the other operations are the same as those of the first embodiment, the description will be omitted.

The second movement speed may be calculation as follows. That is, the first movement speed and a first threshold value Vth are compared. If it is higher than the first threshold value, the second movement speed is determined as being equal to Va. If it is equal to or lower than the first threshold value, the second movement speed is determined as being equal to Vb. Expression 6 is an actual conversion equation.

V2=Va(V1<Vth)

V2=Vb(Vth≦V1) Expression 6:

This calculation method calculates the second movement speed from the first movement speed. For example, between the second movement speeds Va and Vb, Va may be a low movement speed at which an observer may observe an analyte in detail, and Vb may be a slightly higher movement speed at which an observer may observe an analyte schematically. For example, the accuracy is not important here, but in order to observe the entire image as quickly as possible, the mouse 109 may be moved quickly to scroll at the second movement speed Vb. In order to observe in detail by taking time, the mouse 109 may be moved slowly to scroll at the second movement speed Va. In this manner, in accordance with the operation on the mouse 109 by an observer, a preset movement speed may be selected for observation, which allows observation under a fixed observation condition, compared with the first embodiment. This provides a benefit that observations may be implemented under an equal condition independent of the variations in the ability of observers or the level of the skill for the operations on the mouse 109 by observers, preventing variations in result by observers. More threshold values may be provided, and more types of second movement speed may be provided.

In this manner, the scroll control method of the second embodiment allows easy scrolling for comprehensive check of the entire image without unobserved parts.

According to the scroll method of the second embodiment, an analyte may automatically be scrolled and displayed in accordance with the direction of movement (second direction of movement) that is preferably for its observation and the movement speed (second movement speed) that is preferably for its observation. Therefore, this may reduce the load imposed on the observer who designates a scroll operation. As a result, the observer may be allowed to concentrate his or her observation. Furthermore, compared with the first embodiment, because the second movement speed is limited to be of a plurality of types, observations may be implemented under an equal condition independent of the variations in the ability of observers or the level of the skill for the operations on the mouse 109 by observers, preventing variations in result by observers.

### Third Embodiment

Next, a third embodiment will be described. The third embodiment according to the first embodiment or second embodiment further includes automatically switching the mode of an operation associated with dragging with the mouse 109.

In general, when the mouse 109 is dragged to manually scroll for moving an image in accordance with the movement of the pointer, an observer performs the operation at a generally low movement speed. The method according to the third embodiment uses this characteristic to allow automatic switching by a computer between a manual scrolling mode and the scrolling mode, without switching by an observer.

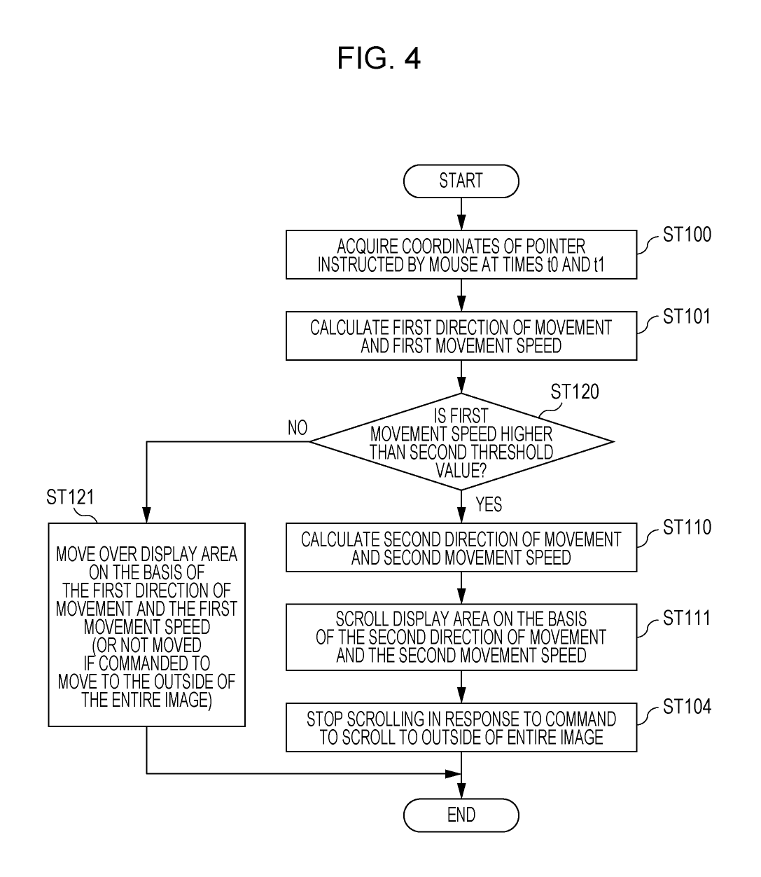

FIG. 4 is a flowchart illustrating an operation by the viewer which implements the third embodiment. The details of the operation will be described with reference to the flowchart in FIG. 4.

Unlike the first and second embodiments, the presetting of a mode is not necessary according to the third embodiment.

The following operation is performed in accordance with the flowchart in FIG. 4 when the mouse 109 moves with a button thereon selected (dragged). The coordinates of the pointer instructed through the mouse 109 at times t0 and t1 are acquired (step ST100). Next, from the coordinates of the pointer instructed through the mouse 109 at times t0 and t1, a first direction of movement and a first movement speed are acquired (first calculation step: step ST101). Details on how to acquire the coordinates are as described above. Next, the first movement speed and a second threshold value are compared. If the first movement speed is lower, the manual scrolling is determined (step ST120). Then, a normal manual scrolling operation is performed on the basis of the first direction of movement and first movement speed (step ST121), and the processing returns to check the next operation on the mouse 109 (return to START). On the other hand, if the first movement speed is equal to or higher than the second threshold value in step ST120, the scrolling is determined, and the processing moves to the following steps.

In step ST110 (second calculation step), from the first direction of movement and the first movement speed, a second direction of movement and a second movement speed are calculated. For example, the second direction of movement may be calculated in the same manner as the first embodiment. The second movement speed may be calculated from the first movement speed, as in the second embodiment. However, because it is determined that the first movement speed is equal to or higher than the second threshold value, it is difficult of the observer to designate to operate the mouse 109 at a plurality of types of speed that are equal to or higher than the second threshold value. For that, one type of second movement speed may be provided and may be determined as the second movement speed in step 110.

Next, a display area is moved at the second movement speed in the second direction of movement for display (step ST111). Then, when the display area reaches an end of the entire image of the observation object, the movement of the display area stops (step ST104). The operation in step ST104 may further includes the operation according to the first embodiment.

In this manner, the scroll control method of the second embodiment allows easy scrolling for comprehensive check of the entire image without unobserved parts, without the necessity for taking time for mode switching.

According to the scroll method of the third embodiment, an analyte may automatically be scrolled and displayed in accordance with the direction of movement (second direction of movement) that is preferably for its observation and the movement speed (second movement speed) that is preferably for its observation, like the first embodiment. Therefore, according to the scroll method of the third embodiment, a less load may be imposed on the observer who designates a scroll operation. As a result, the observer may be allowed to concentrate his or her observation. Furthermore, like the second embodiment, because the second movement speed is limited to be of a plurality of types (or more preferably one type), observations may be implemented under an equal condition independent of the variations in the ability of observers or the level of the skill for the operations on the mouse 109 by observers, preventing variations in result by observers.

Furthermore, comparing the first movement speed and the second threshold value and switching between the manual scrolling and the scrolling according to the third embodiment may eliminate the necessity for taking time for the mode switching, which is necessary in the first and second embodiments, and a more efficient observation on an analyte may thus be implemented.

### Fourth Embodiment

Next, a fourth embodiment will be described. The fourth embodiment reduces motion blur as much as possible even when the display apparatus 2 is a hold type display as described above and allows observations without interference when scrolling is automatically performed at a designated scrolling speed.

More specifically, in order to avoid movement blur, scrolling is performed by periodically switching between a scrolling speed for observation and a scrolling speed for movement. Particularly, in order to scroll, the operation as described above is repeated in cycles of the position where a displayed image area overlaps with the direction of scrolling.

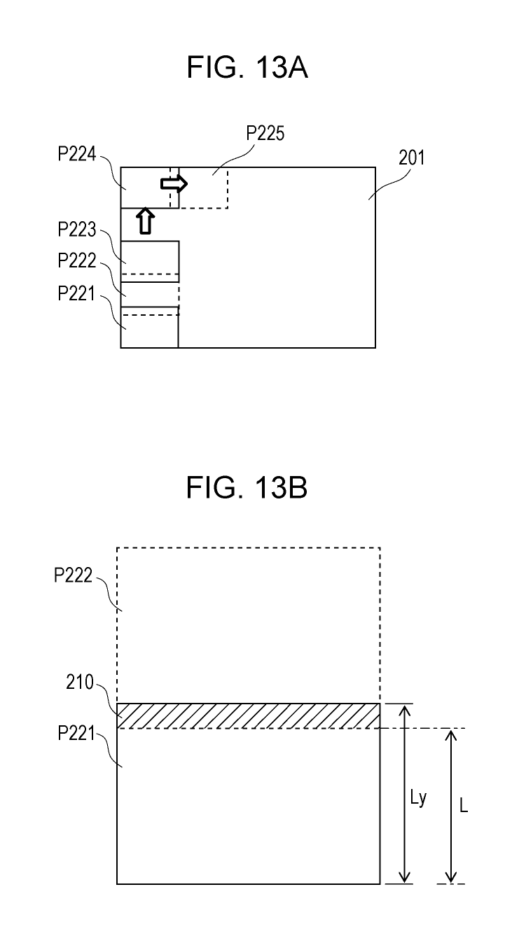

FIGS. 13A and 13B illustrate scrolling of a viewer of the fourth embodiment. FIG. 13A schematically illustrates an operation of scrolling an image to be observed in a longitudinal direction. FIG. 13B is a zooming view of a part of FIG. 13A. FIG. 13B illustrates scrolling in a longitudinal direction, but this embodiment is applicable to the scrolling in a lateral direction as illustrated in FIG. 12B.

Descriptions on the reference numerals described above will be omitted in FIGS. 13A and 13B. In FIGS. 13A and 13B, partial areas P221 to P225 of the image to be observed are display areas which may be displayed on a display apparatus at certain times.

The display area P221 moves upward (scrolling in the longitudinal direction) and moves in the right direction (scrolling in the lateral direction) such that the display areas may partially overlap at the upper end (P224) of the image to be observed (P225). After that, the display area is moved downward for sequential display. Such scrolling allows close observation of the entire image of the observation object.

FIG. 13B illustrates a relationship between display areas for clearly understanding the scrolling of the fourth embodiment. FIG. 13B illustrates that the display area (solid line) P221 moves upward and partially overlaps with the display area (broken line) P222 (which is indicated by the shaded area 210). The overlapping travel distance L may be determined as Expression 7:

L=K×Ly

where the length in the longitudinal direction of the display area is Ly and K is determined in the range from 0.5 to 0.9 by an observer, for example, for clear observation. The overlapping area 210 is particularly important when a third movement speed is equal to zero, which will be described below. The presence of the overlapping area 210 may be usable for easy understanding of the positional relationship of an analyte to be observed.

The fourth embodiment provides a scroll method of moving the display area at the movement speeds which are periodically changing between a third movement speed and a fourth movement speed that is higher than the third movement speed when the time for moving at a designated scrolling speed the overlapping travel distance L is handled as a cycle.

This scroll method periodically repeats a lower speed for observation than a designated scrolling speed (third movement speed) and a higher speed for moving the display area (fourth movement speed). The observer may gaze at an image scrolled at the third movement speed with less motion blur. As a result, because the observer may observe a clear image without blur, the accuracy of the observation may be improved.

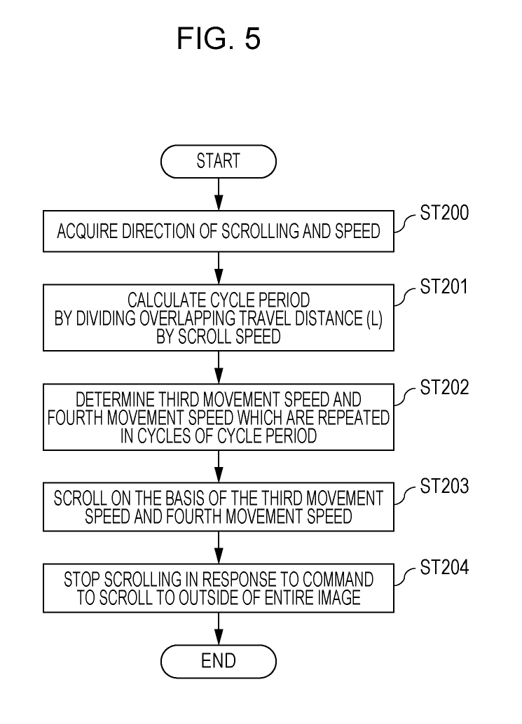

The viewer scroll method may be implemented by the computer system illustrated in FIG. 10. FIG. 5 is a flowchart illustrating an operation by a viewer that implements the fourth embodiment. Unlike the first to third embodiments, the scrolling speed is designated in advance according to the fourth embodiment. The scrolling speed may be designated according to any one of the first to third embodiments.

The fourth embodiment will be described in detail with reference to the flowchart in FIG. 5. First, the direction of movement and movement speed for scrolling are acquired (step ST200). The direction of movement and movement speed may be directly designated by an observer as described above or may be designated according to any one of the first to third embodiments. A value depending on the type of analyte to be observed may be used. Next, the time (repetition cycle) required for moving is calculated by dividing the overlapping travel distance (L) by a designated scrolling distance in step ST201. In the next step ST202, a third movement speed and a fourth movement speed that is higher than the third speed, which are changed in the repetition cycles are determined. Details on how to determine them will be described below. In the next step ST203, the display area is moved (or scrolled) on the basis of the third speed and the fourth movement speed. When the display area reaches an end of the entire image of the observation object, the movement of the display area stops (step ST104). The scroll starting position is the display area P221, and the scroll end position is the display area P224. During the period from the scroll start to the end, scrolling is performed by repeating the third movement speed and the fourth movement speed a plurality of number of times. This operation allows the observer to observe without caring motion blur on a display apparatus such as an LCD.

Next, how to determine the third movement speed and fourth movement speed in step ST202 will be described.

Fundamentally, the third movement speed and fourth movement speed are determined such that the average of periodically change the third movement speed and fourth movement speed may be equal to a preset movement speed. Furthermore, the time for moving at the third movement speed may be determined longer than the time for moving at the fourth movement speed. The third movement speed may be determined as being equal to zero. The third movement speed and fourth movement speed may be determined such that the change from the third movement speed to the fourth movement speed may be continuous.

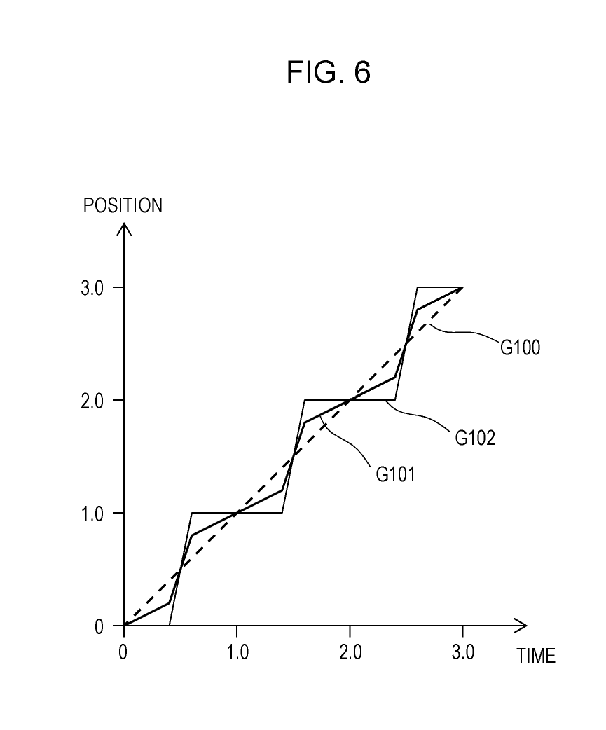

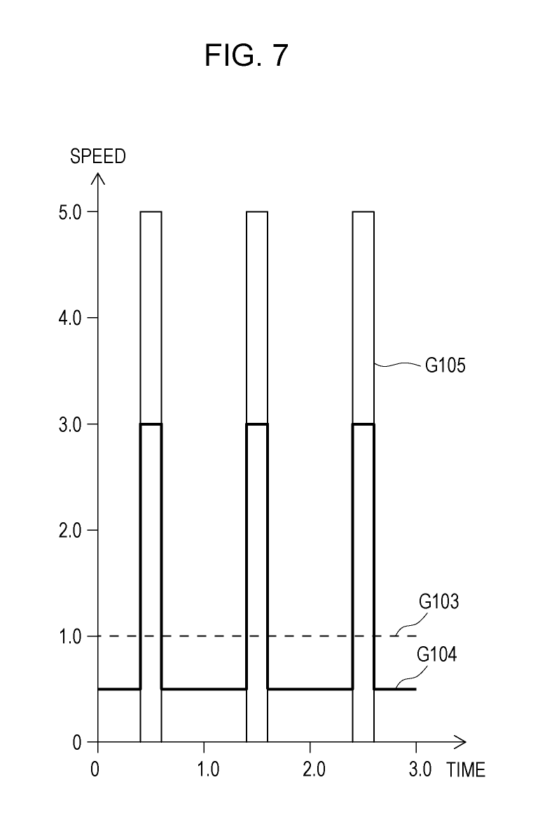

FIG. 6 is a graph illustrating a relationship between the time and position of the display area of scrolling according to the fourth embodiment. In FIG. 6, the lateral axis indicates a time standardized with the repetition cycle, and the longitudinal axis indicates the position standardized with the overlapping travel distance L. In FIG. 6, a straight line G100 (broken line) is produced by scrolling at a designated scrolling speed. The thick solid line G101 is an example of the fourth embodiment, and the thin solid line G102 is another example of the fourth embodiment. As illustrated in the graph, the average speeds are determined as being equal to each other. G101 is determined such that the third movement speed may be ⅙ of the fourth movement speed and that the third movement speed may be the time equal to 80% of the repetition cycle. The third movement speed is half of the designated scrolling speed, and the scrolling at the third movement speed may produce less motion blur on an analyte. G102 is determined such that the third movement speed may be equal to zero, and the third movement speed may be the time equal to 80% of the repetition cycle. The fourth movement speed is then determined as being equal to five times of the designated scrolling speed. These determinations may implement scrolling at the third movement speed (0) (that is, a stopping state), which does not cause motion blur on an analyte. As a result, the observer may observe well. Furthermore, a necessary and sufficient time is provided for observation (the time at the third movement speed) since it is 80% of the repetition cycle. FIG. 7 is a graph illustrating a relationship between the time and movement speed according to the fourth embodiment. For clear illustration, FIG. 7 has a lateral axis indicating a time standardized with the repetition cycle and a longitudinal axis indicating a movement speed calculated from a distance standardized with the overlapping travel distance L and the time standardized with the repetition cycle. The G100 (broken line) in FIG. 6 corresponds to G103 (broken line) in FIG. 7. G101 (thick solid line) in FIG. 6 corresponds to G104 (thick solid line) in FIGS. 7, and G102 (thin solid line) in FIG. 6 corresponds to G105 (thin solid line) in FIG. 7.

Determining the third movement speed and the fourth movement speed in the manner as described above allows an observer to observe an image of an analyte by scrolling at the low third movement speed. This results in less (or no) motion blur and allows more accurate observation. The time at the third movement speed may be increased, which may reduce the decrease in observation time.

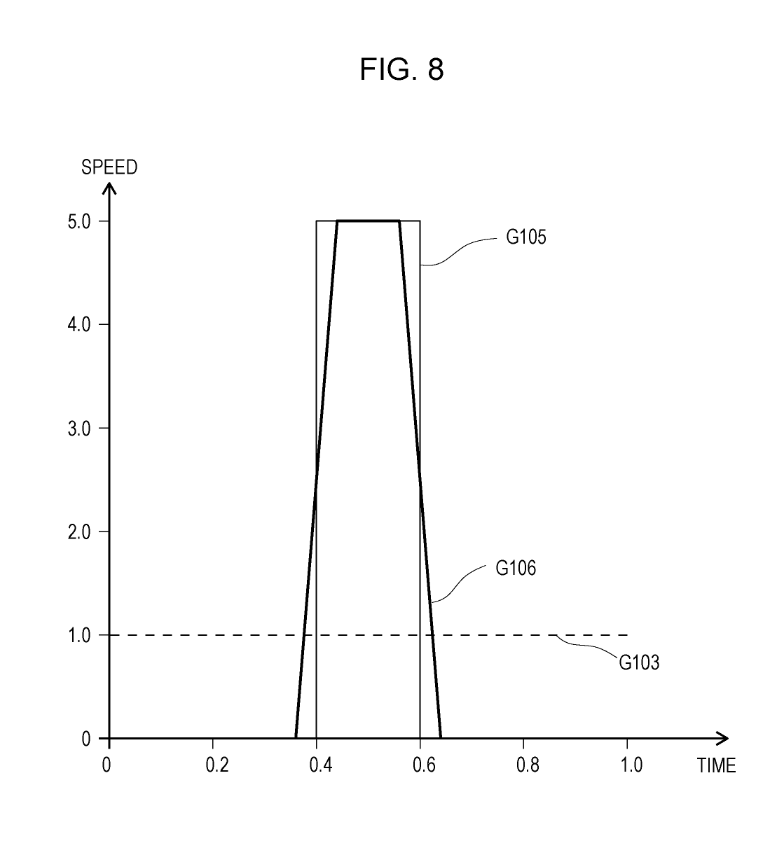

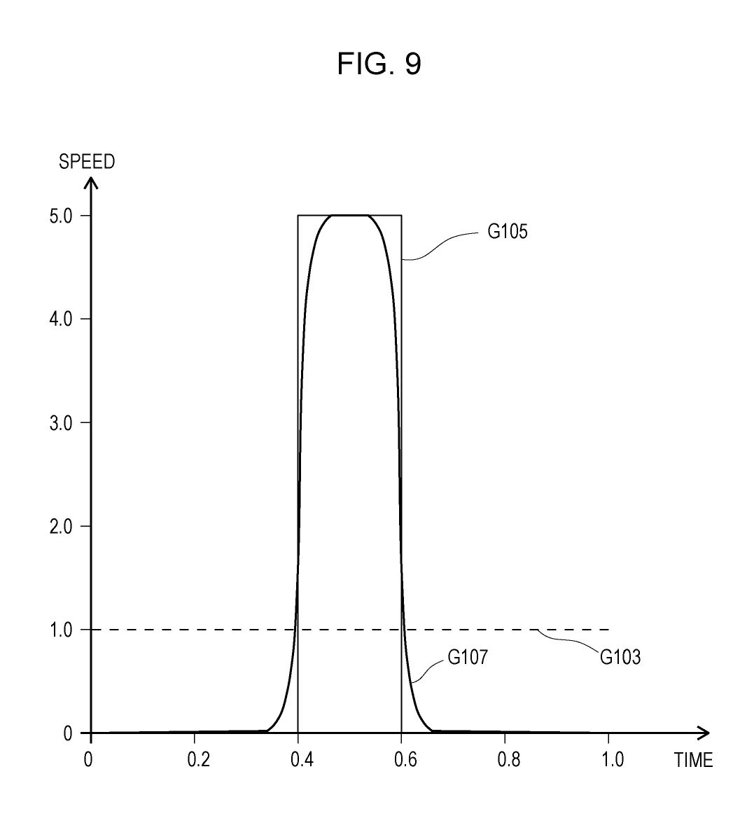

Some observers may feel that the scrolling is not smooth upon switching between the third movement speed and the fourth movement speed and feel strange though the scrolling produces less (or no) motion blur. In order for observers not to feel strange, the scrolling may be performed with the characteristic illustrated in FIG. 8. FIG. 8 is a graph illustrating an improved relationship between time and movement speed of the fourth embodiment. FIG. 8 has a lateral axis indicating a time standardized with the repetition cycle and a longitudinal axis indicating a movement speed calculated from a distance standardized with the overlapping travel distance L and the time standardized with the repetition cycle, as in FIG. 7. The G103 and G105 in FIG. 8 indicate the characteristics of the G103 and G105 illustrated in FIG. 7. G106 (thick solid line) indicates an improved characteristic of the feel of strangeness regarding the characteristic of the G105. As indicated by G106 (thick solid line), the third movement speed (0) and the fourth movement speed are determined such that they are switched to each other continuously. This determination may reduce a sense of strangeness that an observer may feel. Furthermore, setting the characteristic of G107 (thick solid line) illustrated in FIG. 9 may produce a mild change of the speed and may reduce a sense of strangeness. FIG. 9 is a graph illustrating a further improved relationship between the time and movement speed of the fourth embodiment. Because the lateral axis and longitudinal axis in FIG. 9 are the same as those in FIG. 8, the description will be omitted. The characteristics of G103 and G105 are as described above, and G107 is a further improved characteristic of the characteristic of G105. The characteristic of G107 has a slightly shorter time at the third movement speed but may produce scrolling with less sense of strangeness.

If the fourth movement speed is infinitely high, it is not suitable for scrolling. This is because the display area changes instantly and the position relationship of the analyte having been observed up to that point may be lost when the display area changes. For that reason, the fourth movement speed may be kept to the extent that the position relationship of an analyte may be clear in sacrifice of large motion blur.

When the third movement speed is equal to 0, an observer may settle down to his or her observation if the remaining time of the observation, that is the time until the display area starts to move again is available. In order to do so, the remaining time until the display area starts to move again may be displayed in an outside area, for example, of the display window displaying the display area. The time until the display area starts to move again may be indicated by a number, for example, but may be indicated by a design imitating an analog clock or an hourglass or a vanishing dots design that is easy to understand sensibly. More observation time may be necessary for observing an analyte by location. In this case, the scrolling may be controlled such that one hit of a space key on the keyboard 108 may instruct to pause and another hit may instruct to restart scrolling, for example.

In this manner, the scroll control method according to the fourth embodiment may allow scrolling to observe while preventing motion blur.

As described above, because the scroll method according to the fourth embodiment may allow automatic scrolling and display of an analyte at a preferred movement speed for observation, the load imposed on the observer who designates the scroll operation may be reduced. Furthermore, even when a hold type display such as an LCD is used, an observer may observe well by preventing motion blur. As a result, an effect may be provided that may prevent mis-observation due to a malfunction that details may be difficult to observe.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In an example, a computer-readable storage medium may store a program that causes a scroll control apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-286780, filed Dec. 27, 2011 which is hereby incorporated by reference herein in its entirety.

What is claimed is:

1. A scroll control method for aiding works including displaying a partial area of an image of an observation object on a display apparatus and moving a display area within the image to observe the image, the scroll control method comprising:
a first calculation step of calculating, by a computer, a first direction of movement and first movement speed based on information on time and coordinates on a movement selected with a pointing device and instructed to operate;
a second calculation step of calculating, by the computer, a second direction of movement and a second movement speed from the first direction of movement and first movement speed; and
a display control step of performing, by the computer, scroll control over the display area based on the second direction of movement and movement speed.

2. The scroll control method according to claim 1, wherein the second calculation step limits and calculates a possible value of the second direction of movement based on the first direction of movement.

3. The scroll control method according to claim 2, wherein the second calculation step limits and determines the second direction of movement to a longitudinal direction or a lateral direction from the first direction of movement.

4. The scroll control method according to claim 1, wherein the second calculation step further limits and calculates a possible value of the second movement speed based on the first movement speed.

5. The scroll control method according to claim 1, further comprising the step of moving, by the computer and in response to the first movement speed being lower than a second threshold value, the display area based on the first direction of movement and first movement speed and moving, by the computer and in response to the first movement speed being higher than the second threshold value, the display area based on the second direction of movement and second movement speed.

6. The scroll control method according to claim 1, further comprising the step of, by the computer, reducing a scroll movement speed of the display area in a vicinity of an end of an image of an observation object and stopping and keeping the display area at the end of the image.

7. The scroll control method according to claim 6, further comprising the step of, by the computer, moving the display area kept at the end of the image to a next observation start area and stopping and keeping it there.

8. The scroll control method according to claim 1, further comprising the step of, by the computer, stopping scrolling in response to no analyte being present within the display area.

9. A scroll control method for aiding works including displaying a partial area of an image of an observation object on a display apparatus and moving a display area within the image to observe the image, the scroll control method comprising the steps of:
determining, by a computer and in response to a time for moving, at a designated movement speed, a travel distance overlapping display areas in a designated direction of scrolling being handled as a cycle of the time for moving at the designated movement speed, movement speeds which are periodically changing between a third movement speed and a fourth movement speed that is higher than the third movement speed; and
performing, by the computer, scroll control over a displayed image based on the designated direction of scrolling and the movement speeds which are a repeated changing third movement speed and fourth movement speed.

10. The scroll control method according to claim 9, further comprising the step of determining, by the computer, such that an average of the movement speeds which are the repeated changing third movement speed and fourth movement speed are equal to a set movement speed.

11. The scroll control method according to claim 9, further comprising the step of determining, by the computer, such that a time for moving at the third movement speed is longer than a time for moving at the fourth movement speed.

12. The scroll control method according to claim 11, further comprising the step of determining, by the computer, such that the third movement speed is zero.

13. The scroll control method according to claim 9, further comprising the step of determining, by the computer, such that change of the third movement speed and the fourth movement speed occurs serially.

14. A non-transitory computer readable medium storing a program causing a computer to perform the method according to claim 1.

15. A non-transitory computer readable medium storing a program causing a computer to perform the method according to claim 9.

16. A scroll control apparatus for aiding works including displaying a partial area of an image of an observation object on a display apparatus and moving a display area within the image to observe the image, the scroll control apparatus comprising:
a first calculation unit which calculates a first direction of movement and first movement speed based on information on time and coordinates on a movement selected with a pointing device and instructed to operate;
a second calculation unit which calculates a second direction of movement and a second movement speed from the first direction of movement and first movement speed; and
a display control unit which performs scroll control over the display area based on the second direction of movement and movement speed.

17. A scroll control apparatus for aiding works including displaying a partial area of an image of an observation object on a display apparatus and moving a display area within the image to observe the image, the scroll control apparatus comprising:
a determination unit which determines, in response to a time for moving, at a designated movement speed, a travel distance overlapping display areas in a designated direction of scrolling being handled as a cycle of the time for moving at the designated movement speed, movement speeds which are periodically changing between a third movement speed and a fourth movement speed that is higher than the third movement speed; and
a display control unit which performs scroll control over a displayed image based on the designated direction of movement and the movement speeds which are a repeated changing third movement speed and fourth movement speed.
